(19) United States
(12) Patent Application Publication
(10) Pub. No.: US 2010/0115480 A1
(43) Pub. Date: May 6, 2010

(54) LOGIC CIRCUIT DESIGN VERIFICATION APPARATUS, LOGIC CIRCUIT DESIGN VERIFICATION METHOD , AND MEDIUM STORING LOGIC CIRCUIT DESIGN VERIFICATION PROGRAM

(75) Inventor: Shinpei ISODA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/559,260

(22) Filed: Sep. 14, 2009

(30) Foreign Application Priority Data
Nov. 4, 2008 (JP) 2008-283021

(51) Int. Cl. G06F 17/50

(52) U.S. Cl. 716/5; 716/18

(57) ABSTRACT

A logic circuit design verification apparatus includes an inputting unit configured to input a circuit description and an assertion description, an extracting unit configured to extract signal names from the circuit description input by the inputting unit, a lack detector configured to detect a signal name not included in a postulation and a verification requirement in the assertion description input by the inputting unit among the signal names extracted by the extracting unit, and an outputting unit configured to output the signal name detected by the lack detector.

### CROSS-REFERENCE TO RELATED APPLICATION

This application is based upon and claims the benefit of priority from the prior Japanese Patent Application No. 2008-283021, filed on Nov. 4, 2008; the entire contents of which are incorporated herein by reference.

### BACKGROUND OF THE INVENTION

1. Field of the Invention

The present invention relates to a logic circuit design verification apparatus, a logic circuit design verification method, and a medium storing a logic circuit design verification program. More particularly, to a logic circuit design verification apparatus, a logic circuit design verification method, and a medium storing a logic circuit design verification program that are used in assertion-based verification at an upstream step as a process for verifying the logic circuit designs of semiconductor devices.

2. Related Art

As a known verification method to be employed at an upstream step in a process for verifying the logic circuit designs of semiconductor devices, there has been assertion-based verification in which a circuit description describing a logic circuit for a desired feature is compared with an assertion description describing postulations and verification requirements, so as to determine whether the circuit description and the assertion description match each other.

As a known technique for realizing such assertion-based verification, there has been a technique by which a circuit description is compared with a feature description so as to determine whether the two descriptions match each other, and the proportion of signal names in each assertion included in the assertion description matching the signal names in the circuit description is displayed (see Japanese Patent laid-open Publication No. 2007-94891).

Conventionally, developers use those techniques to specify signal names in a circuit description not matching signal names in an assertion description, modify the circuit description until the signal names in the circuit description match the signal names in the assertion description, and then end the assertion-based verification.

By the technique disclosed in Japanese Patent laid-open Publication No. 2007-94891, however, verification is performed on the assumption that there is no error in the assertion descriptions. Therefore, if there is an error due to a human error in the assertion descriptions (for example, if a developer forgets to write some signal names in the assertion description), accurate assertion-based verification cannot be performed. As a result, even if there is an error in the circuit descriptions, the developer works on the assumption that there is no error in the circuit descriptions. Therefore, the developer needs to return to a previous step while carrying out a step after the assertion-based verification. As a result, the load on the developer becomes heavier.

As described above, by the conventional technique, the load on the developer becomes heavier, if the assertion description is incomplete.

### BRIEF SUMMARY OF THE INVENTION

According to a first aspect of the present invention, there is provided a logic circuit design verification apparatus comprising:

an inputting unit configured to input a circuit description and an assertion description;

an extracting unit configured to extract signal names from the circuit description input by the inputting unit;

a lack detector configured to detect a signal name not included in a postulation and a verification requirement in the assertion description input by the inputting unit among the signal names extracted by the extracting unit; and

an outputting unit configured to output the signal name detected by the lack detector.

According to a second aspect of the present invention, there is provided a logic circuit design verification method comprising:

inputting a circuit description and an assertion description;

extracting signal names from the input circuit description;

detecting a signal name not included in a postulation and a verification requirement in the input assertion description among the extracted signal names; and

outputting the detected signal name.

According to a third aspect of the present invention, there is provided a medium storing a logic circuit design verification program comprising:

an inputting instruction configured to input a circuit description and an assertion description;

an extracting instruction configured to extract signal names from the circuit description input by the inputting instruction;

a lack detecting instruction configured to detect a signal name not included in a postulation and a verification requirement in the assertion description input by the inputting instruction among the signal names extracted by the extracting instruction; and

an outputting instruction configured to output the signal name detected by the lack detecting instruction.

### BRIEF DESCRIPTION OF THE DRAWINGS

FIG. 1 is a block diagram showing the configuration of the logic circuit design verification apparatus according to the first embodiment of the present invention.

FIG. 2 is a functional block diagram showing the functions of the processor 10 of FIG. 1.

FIG. 3 is a flowchart showing the procedures in a logic circuit design verifying process according to the first embodiment of the present invention.

FIG. 4 is a table showing register information according to the first embodiment of the present invention.

FIG. 5 is a flowchart showing the specific procedures in the lack detecting process (S303) shown in FIG. 3.

FIG. 6 is a table showing the results of operations performed in the lack detecting process (S303) shown in FIG. 3.

FIG. 7 is a flowchart showing the procedures in a logic circuit design verifying process according to the second embodiment of the present invention.

FIG. 8 is a flowchart showing the procedures in the intermediate parameter extracting process (S703) shown in FIG. 7.

FIG. 9 is a schematic view showing register connection information according to the second embodiment of the present invention.

FIG. 10 is a flowchart showing the procedures in the lack detecting process (S704) shown in FIG. 7.

FIG. 11 is a table showing register information according to the second embodiment of the present invention.

### DETAILED DESCRIPTION OF THE INVENTION

The following is a description of embodiments of the present invention, with reference to the accompanying drawings. The embodiments described below are merely aspects of the present invention, and does not limit the scope of the present invention.

### First Embodiment

First, a first embodiment of the present invention is described. The first embodiment of the present invention is an example of a logic circuit design verification apparatus outputting a signal name not included in an assertion description.

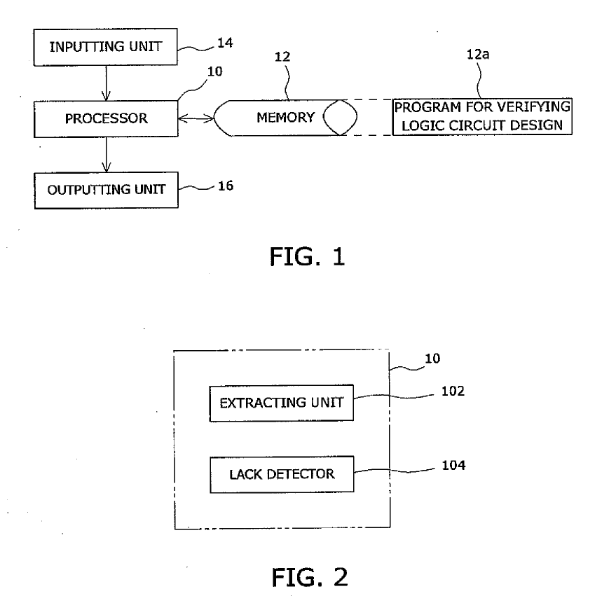

Referring to FIGS. 1 and 2, the configuration of the logic circuit design verification apparatus according to the first embodiment of the present invention is described. FIG. 1 is a block diagram showing the configuration of the logic circuit design verification apparatus according to the first embodiment of the present invention. FIG. 2 is a functional block diagram showing the functions of the processor 10 of FIG. 1.

As shown in FIG. 1, the logic circuit design verification apparatus includes the processor 10 performing various kinds of operations, a memory 12 storing various kinds of data, an inputting unit 14 (such as a keyboard) receiving predetermined commands for the processor 10, and an outputting unit 16 (such as a display) outputting an operation result of the processor 10.

As shown in FIG. 1, the processor 10 is connected to the memory 12, the inputting unit 14, and the outputting unit 16. The processor 10 runs a logic circuit design verifying program 12a stored in the memory 12, so as to realize an extracting unit 102 and a lack detector 104.

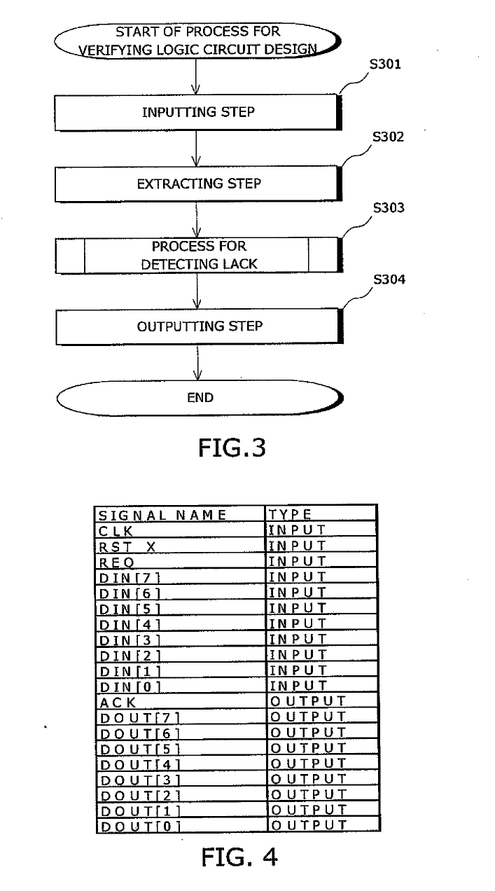

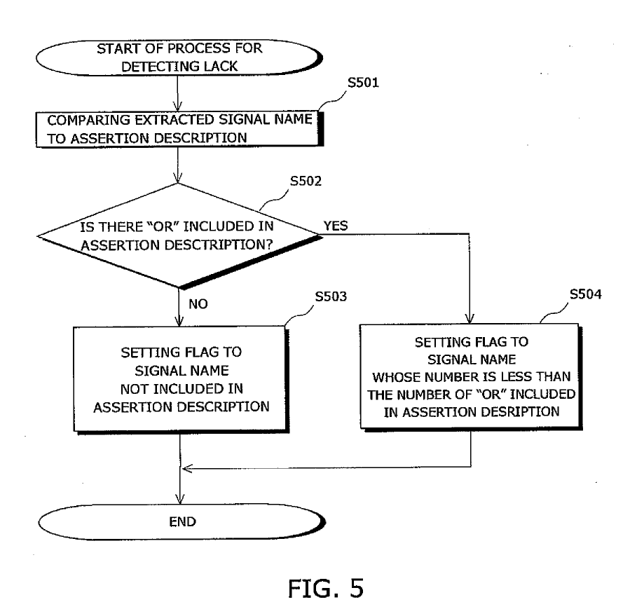

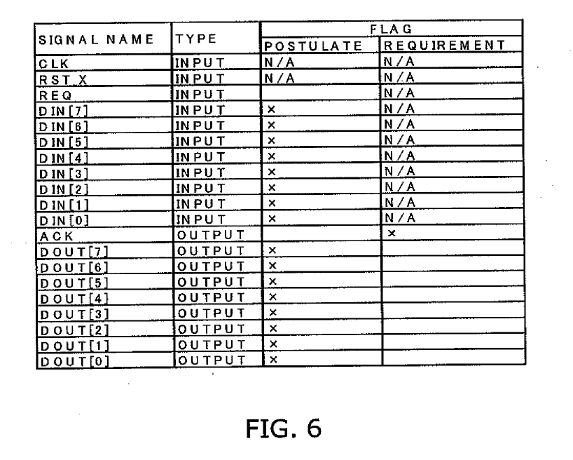

Referring now to FIGS. 3 through 6, the operation of the logic circuit design verification apparatus according to the first embodiment of the present invention is described. FIG. 3 is a flowchart showing the procedures in a logic circuit design verifying process according to the first embodiment of the present invention. FIG. 4 is a table showing register information according to the first embodiment of the present invention. FIG. 5 is a flowchart showing the specific procedures in the lack detecting process (S303) shown in FIG. 3. FIG. 6 is a table showing the results of operations performed in the lack detecting process (S303) shown in FIG. 3.

In the logic circuit design verifying process according to the first embodiment of the present invention, an inputting step (S301) is carried out, as shown in FIG. 3. In the inputting step (S301), the inputting unit 14 inputs a circuit description (such as a Register Transfer Level (RTL) description) including a signal name and clock reset information, and an assertion description (formulas 1.1 through 1.3) including postulations and verification requirements written according to System Verilog Assertion (SVA). Here, the inputting of the circuit description and the assertion description is performed by a developer.

REQ && ACK|=>DOUT==0; [Formula 1.1]

REQ && ACK && (DIN==0∥DIN==1)|=>##9 (DOUT==$past(DIN)+$past(DIN, 2)∥(DOUT==$past(DIN)); [Formula 1.2]

DOUT[0]∥DOUT[1]∥DOUT[2]∥DOUT[3]∥DOUT[4]∥DOUT[5]∥DOUT[6]∥DOUT[7]|->$past(ACK, 3); [Formula 1.3]

Next, as shown in FIG. 3, an extracting step (S302) is carried out. In the extracting step S302, the extracting unit 102 extracts the signal names and the types of registers from the circuit description input in the inputting step (S301). The extracting unit 102 then creates the register information (FIG. 4).

As shown in FIG. 3, the lack detecting process (S303) is then carried out.

In the lack detecting process (S303), the lack detector 104 compares the signal names extracted in the extracting step (S302) with the assertion description input in the inputting step (S301), as shown in FIG. 5 (S501).

If an assertion description (formula 1.1) not including a parallel requirement (OR) is object to be compared (NO in S502), as shown in FIG. 5, a flag is set to a signal name not included in the postulation and the verification requirement in the assertion description (formula 1.1) for the register information (FIG. 4) created in the extracting step S302 (S503).

If an assertion description (formula 1.2 or 1.3) including parallel requirements (OR) is object to be compared (YES in S502), as shown in FIG. 5, a flag is set to a signal name whose number is less than the number of parallel requirements (OR) in the postulations and verification requirements in the assertion description (formula 1.2 or 1.3) for the register information (FIG. 4) created in the extracting step (S302) (S504).

FIG. 6 indicates that input signals DIN and output signals DOUT are not included in the postulations in the assertion descriptions, an output signal ACK is not included in the verification requirements in the assertion descriptions, input signals CLK and RST_X are excluded from the objects to be compared with the postulations and verification requirements in the assertion descriptions, and input signals REQ and DIN are excluded from the objects to be compared with the verification requirements in the assertion descriptions.

As shown in FIG. 5, the lack detecting process (S303) of FIG. 3 is completed after step S503 or S504.

As shown in FIG. 3, the outputting step (S304) is then carried out. In the outputting step (S304), the outputting unit 16 outputs the input signals DIN and the output signals ACK and DOUT as the signal names having flags set thereto among the signal names, that is the register information (FIG. 6) detected in the lack detecting process (S303).

As shown in FIG. 3, the logic circuit design verifying process according to the first embodiment of the present invention comes to an end after the outputting step (S304).

Accordingly, in the first embodiment of the present invention, the input signals CLK, RST_X, REQ, and DIN are excluded from the objects to be compared, because the probability that those signals appear in the verification requirements in assertion descriptions is low. However, the input signals CLK, RST_X, REQ, and DIN may be included in the objects to be compared.

According to the first embodiment of the present invention, when an assertion description is incomplete, the signal names missing from the assertion description are output. In this manner, the developer can easily recognize the signal names missing from each assertion description. Accordingly, the load on the developer can be reduced.

### Second Embodiment

A second embodiment of the present invention is now described. The first embodiment of the present invention is an example of a logic circuit design verification apparatus outputting signal names missing from assertion descriptions. On the other hand, the second embodiment of the present invention is an example of a logic circuit design verification apparatus outputting the degree of attainment of an assertion description with respect to the circuit description. The logic circuit design verification apparatus of the second embodiment of the present invention has the same configuration as the logic circuit design verification apparatus of the first embodiment of the present invention.

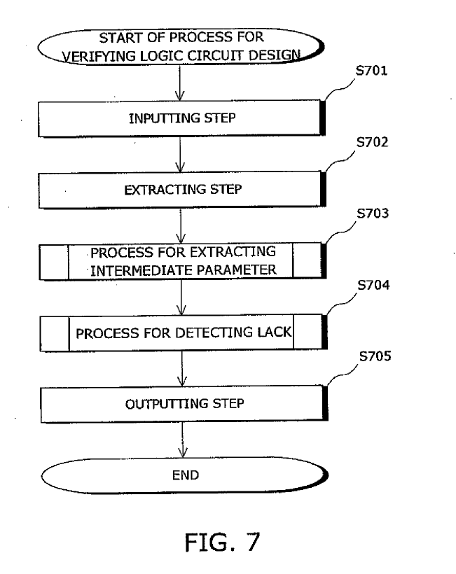

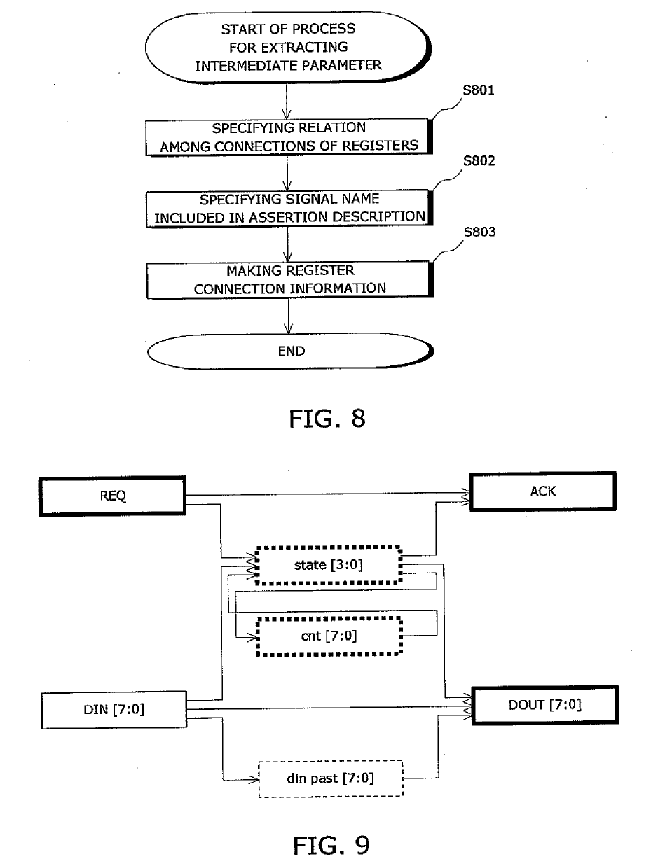

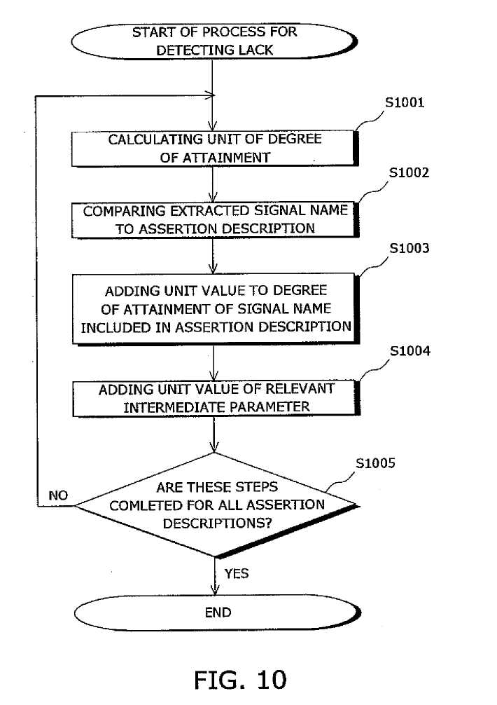

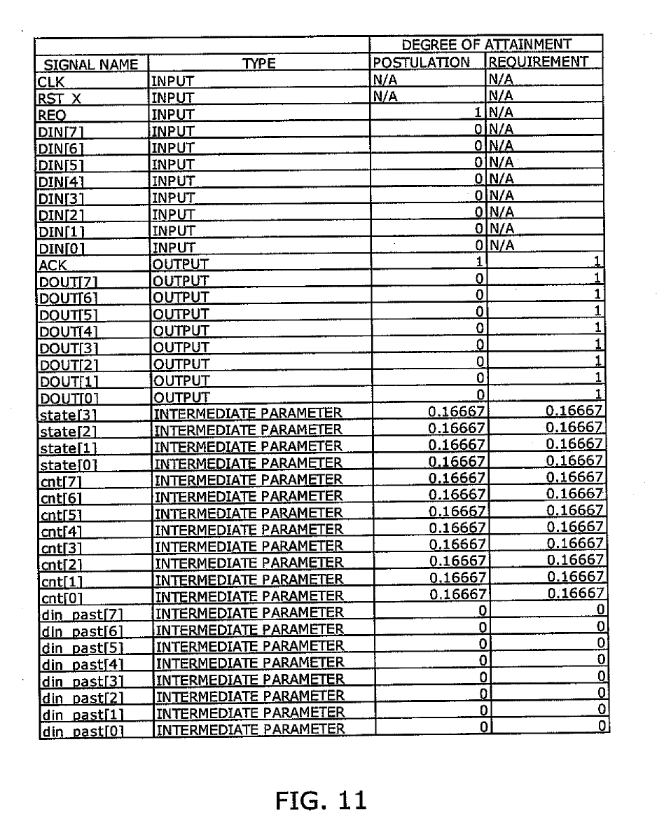

Referring to FIGS. 7 through 11, the operation of the logic circuit design verification apparatus according to the second embodiment of the present invention is described. FIG. 7 is a flowchart showing the procedures in a logic circuit design verifying process according to the second embodiment of the present invention. FIG. 8 is a flowchart showing the procedures in the intermediate parameter extracting process (S703) shown in FIG. 7. FIG. 9 is a schematic view showing register connection information according to the second embodiment of the present invention. FIG. 10 is a flowchart showing the procedures in the lack detecting process (S704) shown in FIG. 7. FIG. 11 is a table showing register information according to the second embodiment of the present invention.

In the logic circuit design verifying process according to the second embodiment of the present invention, an inputting step (S701) is carried out, as shown in FIG. 7. In the inputting step (S701), the inputting unit 14 inputs a circuit description (such as a RTL description) including a signal name and clock reset information, and an assertion description (formula 2.1) including postulations and verification requirements written according to SVA. Here, the inputting of the circuit description and the assertion description is performed by a developer.

REQ && ACK|=>DOUT==7′ h00; [Formula 2.1]

REQ|->##[0:10] ACK; [Formula 2.2]

As shown in FIG. 7, an extracting step (S702) is then carried out. In the extracting step (S702), the extracting unit 102 extracts the signal names and the types of registers from the circuit description input in the inputting step (S701). The extracting unit 102 then creates the register information (FIG. 4).

As shown in FIG. 7, the intermediate parameter extracting process (S703) is then carried out.

In the intermediate parameter extracting process (S703), the extracting unit 102 specifies a connection relation between registers from the circuit description input in the inputting step (S701), as shown in FIG. 8 (S801).

Signal names included in the assertion description (formula 2.1) are then specified with respect to the identified register connection relation, as shown in FIG. 8 (S802).

The intermediate parameters associated with the specified signal names are then extracted, and register connection information (FIG. 9) is created, as shown in FIG. 8 (S803). Here, FIG. 9 indicates that the input signal REQ and the output signals ACK and DOUT are specified as the signal names included in the assertion description (formula 2.1), and the parameters “state” and “cnt” interposed between the specified signal names are extracted as the related intermediate parameters, based on the register information (FIG. 4) and the assertion description (formula 2,1).

As shown in FIG. 8, the intermediate parameter extracting process (S703) shown in FIG. 7 comes to an end after step S803.

As shown in FIG. 7, the lack detecting process (S704) is then carried out.

In the lack detecting process (S704), the lack detector 104 calculates the unit value of the degree of attainment, based on the clock reset information input in the inputting step (S701), as shown in FIG. 10 (S1001). Here, the lack detector 104 sets “1/the number of parallel requirements (OR)” as the unit value of the input signals and output signals, and “1/the total bit of the intermediate parameters” as the unit value of the intermediate parameters.

As shown in FIG. 10, the lack detector 104 then compares the signal names extracted in the extracting step (S702) with the assertion description input in the inputting step (S701) (S1002).

As shown in FIG. 10, the lack detector 104 then adds the unit value to the degree of attainment of the signal names included in the postulation and the verification requirement in the assertion description, with respect to the register information (FIG. 4) created in the extracting step (S702) (S1003). Step S1003 is carried out for each assertion description, and is skipped for each signal name having reached the degree of attainment “1”.

As shown in FIG. 10, the lack detector 104 then adds the unit value to the degree of attainment of the intermediate parameters associated with the signal names included in the postulation and the verification requirement in the assertion description (S1004). Step S1004 is carried out for each assertion description, and is skipped for each signal name having reached the degree of attainment “1”.

As shown in FIG. 10, steps S1001 through S1004 are repeated (NO in S1005) until those steps are carried out for all the assertion descriptions. The lack detecting process (S704) shown in FIG. 7 comes to an end after steps S1001 through S1004 are carried out for all the assertion descriptions (YES in S1005).

FIG. 11 indicates that the input signal REQ and the output signal ACK are included in the postulation in the assertion description, the output signals DOUT are included in the verification requirement in the assertion description, and the degrees of attainment of the intermediate parameters “state” and “cnt” are 0.16667.

As shown in FIG. 7, an outputting step (S705) is then carried out. In the outputting step (S705), the outputting unit 16 outputs the input signals DIN, the output signals DOUT, and intermediate parameters din_past as the signal names having a degree of attainment “0” in the register information (FIG. 11), those are the signal names detected in the lack detecting process (S704). If there is a signal name or intermediate parameter having a degree of attainment lower than a predetermined reference value, the outputting unit 16 outputs an alarm.

As shown in FIG. 7, the logic circuit design verifying process according to the second embodiment of the present invention comes to an end after the outputting step (S705).

Alternatively, the second embodiment of the present invention may be implemented in combination with the first embodiment of the present invention.

Alternatively, in the second embodiment of the present invention, the lack detector 104 may use “1/the number of paths connecting the starting points and the ending points of the intermediate parameters” as the unit value of the intermediate parameters, instead of “1/the total bit of the intermediate parameters”. In such a case, the lack detector 104 adds the unit value to the degrees of attainment of the registers associated with the signal names on the paths.

According to the second embodiment of the present invention, if an assertion description is incomplete, not only the signal names missing from the assertion description but also the degree of attainment of the assertion description are output. In this manner, the developer can recognize the degree of completion of each assertion description. Accordingly, the working efficiency can be higher.

Also, according to the second embodiment of the present invention, the unit value of the degree of attainment of each assertion description is a value that is smaller than “1”. Accordingly, even if the number of registers associated with each assertion description is large, more accurate values can be obtained as the degrees of attainment.

Furthermore, according to the second embodiment of the present invention, an alarm is output when there is a degree of attainment lower than the reference value. Accordingly, the developer can easily notice any deficiency in assertion descriptions. In other words, the developer can easily find an incomplete assertion description.

At least a portion of a logic circuit design verification apparatus according to the above-described embodiments of the present invention may be composed of hardware or software. When at least a portion of the logic circuit design verification apparatus is composed of software, a program for executing at least some functions of the logic circuit design verification apparatus may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the logic circuit design verification apparatus according to the above-described embodiment of the present invention may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

The above-described embodiments of the present invention are just illustrative, but the invention is not limited thereto. The technical scope of the invention is defined by the appended claims, and various changes and modifications of the invention can be made within the scope and meaning equivalent to the claims.

What is claimed is:

1. A logic circuit design verification apparatus comprising:
an inputting module configured to input a circuit description and an assertion description;
an extracting module configured to extract signal names from the circuit description;
a lack detector configured to detect a signal name not included in a postulation and a verification requirement in the assertion description among the signal names; and
an outputting module configured to output the signal name detected by the lack detector.

2. The apparatus of claim 1, wherein, when parallel requirements are included in the assertion description, the lack detector detects a signal name whose number is less than the number of the parallel requirements in the postulation and the verification requirement.

3. The apparatus of claim 1, wherein:
the extracting module extracts intermediate parameters from the circuit description;
the lack detector calculates a degree of attainment of an intermediate parameter associated with a signal name included in the postulation and the verification requirement among the intermediate parameters; and
the outputting module outputs the degree of attainment calculated by the lack detector.

4. The apparatus of claim 3, wherein the lack detector sets a proportion of the number of intermediate parameters included in the postulation and the verification requirement to the total bit of the intermediate parameters as a unit value of the degree of attainment.

5. The apparatus of claim 3, wherein the outputting module outputs an alarm when the degree of attainment calculated by the lack detector is less than a predetermined reference value.

6. The apparatus of claim 2, wherein:
the extracting module extracts intermediate parameters from the circuit description;
the lack detector calculates a degree of attainment of an intermediate parameter associated with a signal name included in the postulation and the verification requirement among the intermediate parameters; and
the outputting module outputs the degree of attainment calculated by the lack detector.

7. The apparatus of claim 6, wherein the lack detector sets a proportion of the number of intermediate parameters included in the postulation and the verification requirement to the total bit of the intermediate parameters as a unit value of the degree of attainment.

8. The apparatus of claim 6, wherein the outputting module outputs an alarm when the degree of attainment calculated by the lack detector is less than a predetermined reference value.

9. The apparatus of claim 4, wherein the outputting module outputs an alarm when the degree of attainment calculated by the lack detector is less than a predetermined reference value.

10. A logic circuit design verification method comprising:
inputting a circuit description and an assertion description;
extracting signal names from the input circuit description;
detecting a signal name not included in a postulation and a verification requirement in the input assertion description among the extracted signal names; and
outputting the detected signal name.

11. The method of claim 10, wherein, when parallel requirements are included in the assertion description, in detecting the signal name, a signal name whose number is less than the number of the parallel requirements is detected.

12. The method of claim 10, wherein:
in extracting the signal names, intermediate parameters from the circuit description are extracted;
in detecting the signal name, a degree of attainment of an intermediate parameter associated with a signal name included in the postulation and the verification requirement among the extracted intermediate parameters is calculated; and
in outputting the detected signal name, the calculated degree of attainment is output.

13. The method of claim 12, wherein in detecting the signal name, a proportion of the number of intermediate parameters to the total bit of the intermediate parameters is set as a unit value of the degree of attainment.

14. The method of claim 12, wherein in outputting the detected signal name, an alarm is output when the calculated degree of attainment is less than a predetermined reference value.

15. The method of claim 11, wherein:
in extracting the signal names, intermediate parameters from the circuit description are extracted;
in detecting the signal name, a degree of attainment of an intermediate parameter associated with a signal name included in the postulation and the verification requirement among the extracted intermediate parameters is calculated; and
in outputting the detected signal name, the calculated degree of attainment is output.

16. The method of claim 15, wherein in detecting the signal name, a proportion of the number of intermediate parameters included in the postulation and the verification requirement to the total bit of the intermediate parameters is set as a unit value of the degree of attainment.

17. The method of claim 15, wherein in outputting the detected signal name, an alarm is output when the calculated degree of attainment is less than a predetermined reference value.

18. The method of claim 13, wherein in outputting the detected signal name, an alarm is output when the calculated degree of attainment is less than a predetermined reference value.

19. A computer readable medium having stored thereon a logic circuit design verification program that, when executed by a computer, causes the computer to:
input a circuit description and an assertion description;
extract signal names from the circuit description;
detect a signal name not included in a postulation and a verification requirement in the assertion description among the signal names extracted by the extracting instruction; and
output the signal name detected by the lack detecting instruction.

20. The medium of claim 19, wherein, when parallel requirements are included in the assertion description, the lack detecting instruction detects a signal name whose number is less than the number of the parallel requirements in the postulation and the verification requirement in the assertion description.
